(19) United States
(12) Patent Application Publication
(10) Pub. No.: US 2026/0065352 A1
(43) Pub. Date: Mar. 5, 2026

(54) GENERATING A REGION- AND SOURCE-AGNOSTIC DATABASE OF ITEMS AVAILABLE IN MULTIPLE REGIONS

(71) Applicant: Maplebear Inc., San Francisco, CA (US)

(72) Inventors: Naval Shah, Toronto (CA); Riddhima Sejpal, Dublin, CA (US)

(21) Appl. No.: 18/821,939

(22) Filed: Aug. 30, 2024

(51) Int. Cl. G06Q 30/0601; G06Q 10/087; G06Q 30/0201

(52) U.S. Cl. CPC G06Q 30/0639; G06Q 10/087; G06Q 30/0201; G06Q 30/0603; G06Q 30/0631

(57) ABSTRACT

An online system retrieves item data for items available at sources in multiple regions and generates candidate nodes based on the item data, in which each candidate node represents items having at least a threshold measure of similarity to each other. The system accesses and applies a machine-learning model to predict a matching score for each combination of an item and a candidate node based on item data for the item and attributes of items represented by the candidate node. The system assigns the items to candidate nodes based on the matching scores, retrieves information describing an availability of each item in each geographical region, and identifies an average availability of items assigned to each candidate node across the geographical regions. The system selects nodes to include in a region- and source-agnostic item database, in which the average availability associated with each selected node is at least a threshold.

### BACKGROUND

Online systems may provide their users with the convenience of allowing them to place orders that the online systems match with pickers who service the orders on behalf of the users. The pickers may service the orders by driving to source locations, collecting items included in the orders, and delivering the orders to the users who placed the orders. When generating ordering interfaces through which the users may order items, the online systems may use information describing geographical locations (e.g., delivery locations) associated with the users to populate the ordering interfaces with items available at source locations within the same geographical regions associated with the users.

However, geographical locations associated with users of online systems may not be available to the online systems. For example, third-party applications that redirect their users to the online systems may not collect information describing geographical locations associated with the users for various reasons (e.g., the applications may not be built to do so, the third parties that build the applications may not want to do so for privacy reasons, etc.). Absent information describing the geographical locations associated with the users, the online systems may present the users with items that are not available in the users' geographical regions. As such, any orders placed by the users that include such items may be more difficult to fulfill, especially if adequate replacements are not available.

### SUMMARY

In accordance with one or more aspects of the disclosure, an online system generates a region- and source-agnostic catalog of items available at source locations in multiple geographical regions using machine learning. More specifically, an online system retrieves a set of item data for each of multiple items available at source locations in multiple geographical regions and generates multiple candidate nodes based at least in part on the set of item data for each item, in which each candidate node represents a group of items having at least a threshold measure of similarity to each other. The online system accesses and applies a machine-learning model to predict a matching score for each combination of an item of the multiple items and a candidate node of the multiple candidate nodes based at least in part on the set of item data for a corresponding item and a set of attributes of the group of items represented by a corresponding candidate node. The online system assigns each item to a candidate node based at least in part on the matching score predicted for each combination, retrieves information describing an availability of each item in each geographical region, and identifies an average availability of one or more items assigned to each candidate node based at least in part on the information. For each candidate node, the online system identifies whether the average availability of the items assigned to the candidate node is at least a threshold availability and selects, from the candidate nodes, a set of nodes to include in a region- and source-agnostic item database, in which the average availability of the items assigned to each selected node is at least the threshold availability.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 is a flowchart of a method for generating a region- and source-agnostic item database of items available at source locations in multiple geographical regions using machine learning, in accordance with one or more embodiments.

FIG. 4 illustrates examples of items assigned to candidate nodes, in accordance with one or more embodiments.

FIG. 5 illustrates an example of nodes included in a region- and source-agnostic item database, in accordance with one or more embodiments.

### DETAILED DESCRIPTION

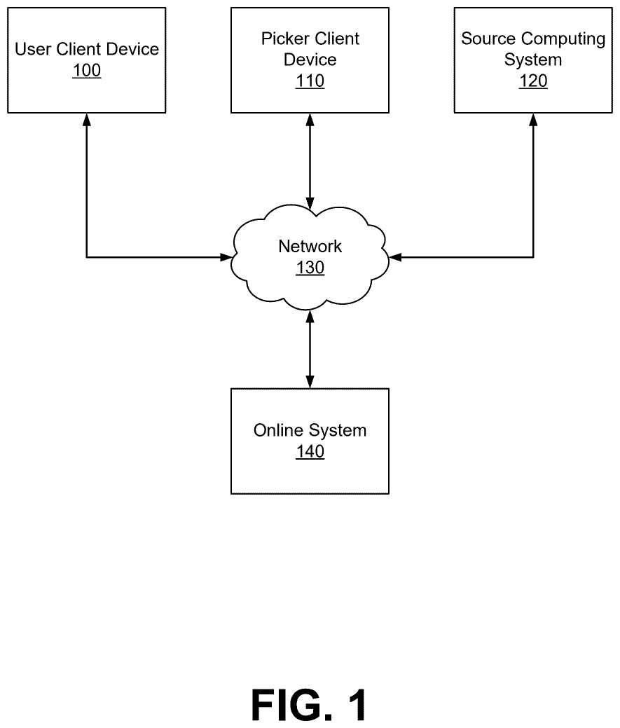

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 may be a personal or mobile computing device, such as a smartphone, a tablet, a laptop computer, or a desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, refers to a good or a product that may be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user may use to place an order with the online system 140. The ordering interface may be part of a client application operating on the user client device 100. The ordering interface allows the user to search for items that are available through the online system 140 and the user may select which items to add to an “ordering list.” An “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the items should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 may be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source location. The picker client device 110 presents the items that are included in the user's order to the picker in a collection interface. The collection interface is a user interface that provides information to the picker identifying items to collect for a user's order and indicating the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source location, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker may use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may identify the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 provides instructions to a picker for delivering the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they may use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system 140 and may receive data describing items that are collected by the user and stored in a storage area of the shopping cart. In some embodiments, the smart shopping cart is a picker client device 110 being operated by a picker collecting items within a source location. Similarly, the smart shopping cart may be a user client device 100 being operated by a user collecting items for themselves within the source location. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, a warehouse, or any other source location from which a picker may collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Furthermore, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 may communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

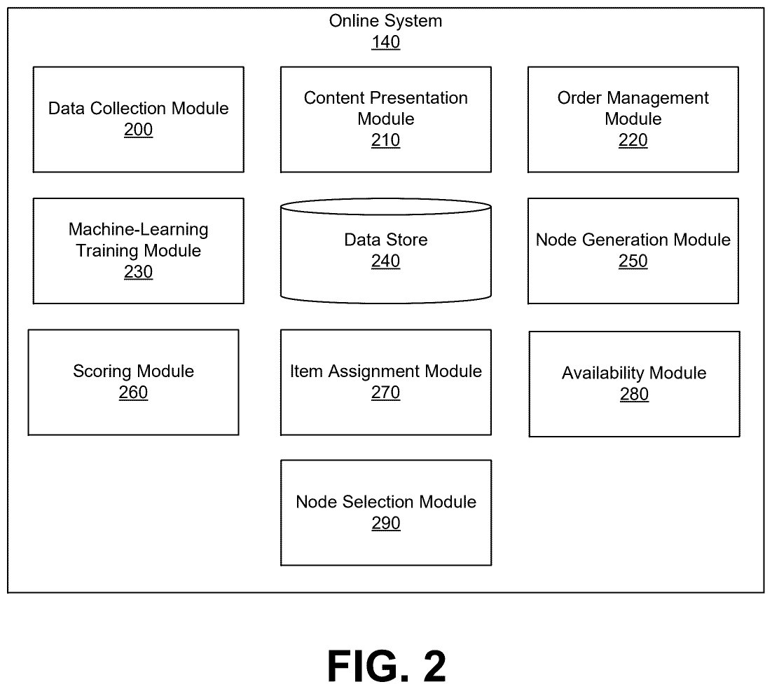

As an example, the online system 140 may allow a user to order groceries from a grocery store source. The user's order may specify which groceries they want to be delivered from the grocery store source and the quantities of each of the groceries. The user's client device 100 transmits the user's order to the online system 140 and the online system 140 selects a picker to travel to the grocery store source location to collect the groceries ordered by the user. The online system 140 transmits an offer to the picker for the picker to service the order in exchange for consideration and, if the picker accepts the offer, the picker collects the groceries from the grocery store source location. Once the picker has collected the groceries ordered by the user, the picker delivers the groceries to a location transmitted to the picker client device 110 by the online system 140. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, a data store 240, a node generation module 250, a scoring module 260, an item assignment module 270, an availability module 280, and a node selection module 290. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

The data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. In addition to a user's address or a delivery location for a user, user data may include a geographical location of a user client device 100 associated with a user or any other additional geographical locations associated with a user. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), serial number, price, item category, brand, quality (e.g., freshness, ripeness, etc.), ingredients/materials, manufacturing location, version/variety (e.g., flavor, low fat, gluten-free, organic, etc.), availability/seasonality, or any other suitable attributes of an item. Item data also may indicate whether a pair of items are interchangeable. Items that are interchangeable may be considered to be equivalent to each other or replacements for each other in an order. Additionally, item data may include a matching score indicating a measure of appropriateness of matching an item with a candidate node representing a group of items having at least a threshold measure of similarity to each other. Information describing an interchangeability of a pair of items or a matching score for a combination of an item and a candidate node may be human-generated or derived by the data collection module 200, as described below. Furthermore, a matching score for a combination of an item and a candidate node may be predicted by the scoring module 260, as also described below. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular source location), the item data may include a time that the item was last found, a time that the item was last not found (a picker looked for the item but could not find it), the rate at which the item is found, or the popularity of the item.

An item category is a set of items that are a similar type of item. Items in an item category may be considered to be equivalent to each other or may be replacements for each other in an order. For example, different brands of sourdough bread may be different items, but these items may be in a “sourdough bread” item category. In some embodiments, item categories are broader in that the same item category may include item types that are related to a common theme, found in the same department, etc. For example, items such as apples, oranges, lettuce, and cucumbers may be included in a “produce” item category. As an additional example, items such as bread, pasta, and cookies that are gluten-free may be included in a “gluten-free” item category, while items such as tortilla chips and tofu that are non-GMO may be included in a “non-GMO” item category. Furthermore, in various embodiments, an item is included in multiple categories. For example, croissants may be included in a “croissant” item category, a “pastry” item category, and a “bakery” item category. The item categories may be human-generated and human-populated with items. The item categories also may be generated automatically by the online system 140 (e.g., using a clustering algorithm).

The item data also may include a hierarchical taxonomy into which items available at a source location are organized, in which different levels of the hierarchical taxonomy provide different levels of specificity about items included in the levels. The data collection module 200 may receive a hierarchical taxonomy from a source or it may generate the hierarchical taxonomy from the item data. The data collection module 200 may generate a hierarchical taxonomy by applying a trained classification model to item data to include different items in levels of the hierarchical taxonomy, such that specific items are associated with item categories corresponding to levels within the hierarchical taxonomy. The data collection module 200 may maintain a hierarchical taxonomy (e.g., as new item data is received, as the item data is updated, etc.).

A hierarchical taxonomy may identify an item category and associate one or more specific items with the item category. For example, if an item category identifies “milk,” a hierarchical taxonomy may associate identifiers of different milk items (e.g., milk having one or more different attributes) with the item category. Thus, a hierarchical taxonomy maintains associations between an item category and specific items available at a source location matching the item category. Furthermore, different levels of a hierarchical taxonomy may identify items with differing levels of specificity based on any suitable attribute or combination of attributes of the items. For example, different levels of a hierarchical taxonomy may specify different combinations of attributes of items, such that items in lower levels of the hierarchical taxonomy share a greater number of attributes, corresponding to greater specificity in an item category, while items in higher levels of the hierarchical taxonomy share a fewer number of attributes, corresponding to less specificity in an item category. In this example, higher levels of the hierarchical taxonomy may include a greater number of items satisfying a broader item category, while lower levels of the hierarchical taxonomy may include a fewer number of items satisfying a more specific item category. The data collection module 200 may collect item data from a source computing system 120, a picker client device 110, or a user client device 100. The data collection module 200 also may collect item data from other components of the online system 140.

The data collection module 200 also may collect catalog data, which is information or data that identifies and describes a database, or catalog, of items, such as a region- and source-agnostic catalog. A region- and source-agnostic catalog includes nodes that each represent a group of items having at least a threshold measure of similarity to each other. Furthermore, an average availability of one or more items assigned to each node of a region- and source-agnostic catalog across multiple geographical regions is at least a threshold availability. The geographical regions in which these source locations are located may be specified by or associated with an entity (e.g., a third-party application developer, a social media influencer, etc.) associated with the region- and source-agnostic catalog. For example, if an entity associated with a region- and source-agnostic catalog specifies that the catalog is to be for geographical regions corresponding to particular cities, items available at source locations within the cities may be assigned to nodes of the region- and source-agnostic catalog, in which an average availability of one or more items assigned to each node across the cities is at least a threshold availability. In the above example, if the entity does not specify the geographical regions corresponding to the cities, but the entity is associated with the cities (e.g., user client devices 100 that access the online system 140 via a third-party application developed by the entity are located in the cities), items available at the source locations within the cities similarly may be assigned to the nodes of the region- and source-agnostic catalog. The data collection module 200 may collect catalog data from other components of the online system 140.

The data collection module 200 also may collect node data, which is information or data that identifies and describes candidate nodes or nodes included among catalogs of items, such as region- and source-agnostic catalogs or source-agnostic catalogs. Node data may include information describing a group of items represented by a node/candidate node and one or more items assigned to each node/candidate node. Information describing a group of items represented by a node/candidate node may include a set of attributes of the group of items. Similarly, information describing one or more items assigned to a node/candidate node may include a set of attributes of the items. For example, information describing a group of items represented by a node/candidate node may include an item category, a size, ingredients/materials, a version/variety, etc. shared by the group of items, while information describing one or more items assigned to the node/candidate node may include an item category, a size, ingredients/materials, a version/variety, etc. of each item. The data collection module 200 may collect node data from other components of the online system 140.

The data collection module 200 also collects picker data, which is information or data describing characteristics of pickers. For example, the picker data for a picker may include the picker's name, the picker's location, how often the picker has serviced orders for the online system 140, a user rating for the picker, the sources from which the picker has collected items, or the picker's previous shopping history. Additionally, the picker data may include preferences expressed by the picker, such as their preferred sources for collecting items, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data describing characteristics of an order. For example, order data may include item data for items that are included in an order, a delivery location for the order, a user associated with the order, a source location from which the user wants the ordered items collected, or a timeframe within which the user wants the order delivered. Order data may further include information describing how the order was serviced, such as which picker serviced the order, whether any items included in the order were not available, whether any items included in the order that were not available were replaced with other items, when the order was delivered, or a rating that the user gave the delivery of the order. In some embodiments, the order data include user data for users associated with the order, such as user data for a user who placed the order or picker data for a picker who serviced the order. In various embodiments, the order data also include feedback received from users associated with orders placed by the users. For example, order data may include information indicating a measure of satisfaction of a user with a replacement for an item included in an order placed by the user.

The data collection module 200 also may collect purchase data, which is information or data describing characteristics of a purchase by a user who collected and purchased items for themselves from a source location. The purchase data may include item data for items included in purchases or user data for users associated with purchases. For example, purchase data for a purchase may include item data for items that are included in the purchase, user data for a user who made the purchase, and information describing the purchase (e.g., a source location from which the user purchased the items and a date and time of the purchase). The purchase data also may include information describing whether users were able to find items at source locations. The data collection module 200 may collect purchase data from a source computing system 120, a user client device 100, or any other suitable source of purchase data.

Furthermore, the data collection module 200 may collect source data, which is information or data identifying and describing characteristics of a source. Source data may include information identifying a source (e.g., a name of the source) and information describing one or more source locations operated by the source, such as a geographical location (e.g., an address) of each source location, hours of operation of each source location, etc. Furthermore, source data may include information describing a geographical region in which a source location is located. For example, source data may include information describing a particular zip code, postal code, county, state, or country in which a source location is located or a particular area of a state (e.g., the San Francisco Bay Area) or a country (e.g., the Midwestern United States) in which a source location is located. The data collection module 200 may collect source data from a source computing system 120 or any other suitable source of source data.

In some embodiments, the data collection module 200 also may derive information from other data stored in the data store 240 and then store this derived information in the data store 240 (e.g., in association with the data from which it was derived). For example, based on order data describing items included in orders, replacements for items included in the orders, and user feedback for orders indicating the users' satisfaction with the replacements, the data collection module 200 may derive information indicating whether pairs of items are interchangeable. In this example, if at least a threshold number or percentage of users who received an item as a replacement for another item were satisfied with the replacement, the data collection module 200 may derive information indicating the pair of items is interchangeable. Similarly, in this example, if less than the threshold number or percentage of users were satisfied with the replacement, the data collection module 200 may derive information indicating the pair of items is not interchangeable. As an additional example, based on item data indicating whether various pairs of items are interchangeable, the data collection module 200 may derive a matching score indicating a measure of appropriateness of matching an item with a candidate node representing a group of items having at least a threshold measure of similarity to each other. In this example, the measure of appropriateness may be proportional to a percentage of items in the group that are interchangeable with the item. As yet another example, based on user data describing geographical locations associated with user client devices 100 associated with users who access the online system 140 via a third-party application, the data collection module 200 may derive one or more geographical regions associated with an entity associated with the third-party application (e.g., a third-party application developer, a social media influencer, etc.).

While user data, picker data, item data, order data, purchase data, source data, catalog data, and node data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. In this example, the content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that a user will order an item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The content presentation module 210 also may receive a request from a user client device 100 associated with a user to access a user interface (e.g., the ordering interface) including information describing a set of items assigned to one or more nodes included in a catalog of items, such as a region- and source-agnostic catalog. The content presentation module 210 may then retrieve a set of item data for each item from the data store 240 and generate the user interface including information describing the set of items. In some embodiments, the content presentation module 210 also retrieves a set of user data for the user describing a geographical location associated with the user and identifies a subset of the set of items available at one or more source locations within a threshold distance of the geographical location associated with the user or within the same geographical region as the geographical location associated with the user. In such embodiments, the content presentation module 210 then generates the user interface including information describing the subset of the set of items. Once the content presentation module 210 generates the user interface, the content presentation module 210 may then send the user interface to the user client device 100, causing the user client device 100 to display the user interface.

The order management module 220 manages orders for items from users. The order management module 220 receives orders from user client devices 100 and offers the orders to pickers for service based on picker data. For example, the order management module 220 offers an order to a picker based on the picker's location and the source location from which the ordered items are to be collected. The order management module 220 may also offer an order to a picker based on how many items are in the order, a vehicle operated by the picker, the delivery location, the picker's preferences for how far to travel to deliver an order, the picker's ratings by users, or how often the picker agrees to service an order.

In some embodiments, the order management module 220 determines when to offer an order to a picker based on a delivery timeframe requested by the user who placed the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions indicating how the picker may travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model is used by the machine-learning model to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, order data, purchase data, source data, catalog data, or node data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

In embodiments in which the scoring module 260 accesses and applies the matching prediction model to predict a matching score for a combination of an item and a candidate node, as described below, the machine-learning training module 230 may train the matching prediction model. The machine-learning training module 230 may train the matching prediction model via supervised learning or using any other suitable technique or combination of techniques based on data stored in the data store 240 or any other suitable types of data. For example, the machine-learning training module 230 may train the matching prediction model based on item data, order data, node data, or any other types of data stored in the data store 240.

To illustrate an example of how the machine-learning training module 230 may train the matching prediction model, suppose that the machine-learning training module 230 receives a set of training examples including a set of attributes (e.g., item categories, ingredients/materials, versions/varieties, sizes, brands, etc.) of a group of items represented by each of multiple candidate nodes generated by the node generation module 250, as described below. In this example, the set of training examples also may include a set of attributes (e.g., item categories, ingredients/materials, versions/varieties, sizes, brands, etc.) of a set of items. In the above example, for each item included among the set, the machine-learning training module 230 also may receive labels which represent expected outputs of the matching prediction model, in which a label corresponds to a matching score indicating a measure of appropriateness of matching the item with a candidate node. Continuing with this example, the machine-learning training module 230 may then update a set of parameters of the matching prediction model based on the sets of attributes, as well as the labels by comparing its output from input data of each training example to the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases in which the training example includes a label, the loss function is also based on the label for the training example. Some example loss functions include the mean square error function, the mean absolute error, the hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, picker data, purchase data, source data, catalog data, and node data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The node generation module 250 retrieves a set of item data for each of multiple items available at multiple source locations, in which the source locations are located in multiple geographical regions. Examples of geographical regions include counties, states, or countries or areas within a county, a state, or a country. For example, the node generation module 250 may retrieve a set of item data for each of multiple items available at source locations in every state in the United States. In this example, the set of information may describe a size, a color, a weight, a SKU, a serial number, a price, an item category, a brand, a quality (e.g., freshness, ripeness, etc.), ingredients/materials, a manufacturing location, a version/variety (e.g., flavor, low fat, gluten-free, organic, etc.), an availability/seasonality, or any other suitable attributes of each item. In embodiments in which the item data includes a hierarchical taxonomy into which items available at each source location are organized, the node generation module 250 also may retrieve the hierarchical taxonomy for each source location.

The node generation module 250 also generates candidate nodes based on item data for various items, in which each candidate node represents a group of items having at least a threshold measure of similarity to each other. In some embodiments, the node generation module 250 generates the candidate nodes using item embeddings describing items, which may be generated by a machine-learning model and stored in the data store 240, as described above. In such embodiments, the node generation module 250 may group the item embeddings into clusters using a clustering algorithm (e.g., k-means, hierarchical clustering, etc.) and generate the candidate nodes based on the clusters (e.g., such that each candidate node corresponds to a cluster and represents a group of items associated with item embeddings included in the cluster). In various embodiments, the node generation module 250 generates the candidate nodes based on a level of a taxonomy (e.g., a hierarchical taxonomy) associated with each item. For example, the node generation module 250 may generate the candidate nodes based on higher levels of a hierarchical taxonomy that include at least a threshold number of items, such that each candidate node represents items included in each level of the hierarchical taxonomy that includes at least the threshold number of items. In some embodiments, the candidate nodes are manually curated. For example, a group of items represented by a candidate node may be manually curated to include items having different attributes, such as different sizes or different quantities per unit. Once the node generation module 250 generates a candidate node, it may communicate information describing the candidate node (e.g., attributes of a group of items the candidate node represents) to the data collection module 200, which may store it among the node data in the data store 240.

The scoring module 260 predicts a matching score for a combination of an item and a candidate node. A matching score may correspond to a value that indicates a measure of appropriateness of matching an item with a candidate node based on a measure of similarity between the item and other items that are members of a group of items represented by the candidate node. The scoring module 260 may predict a matching score for a combination of an item and a candidate node based on a set of item data for the item (e.g., a set of attributes of the item) and a set of node data for the candidate node (e.g., a set of attributes of a group of items represented by the candidate node). For example, a matching score for a combination of an item and a candidate node may be a value from zero to one, in which a matching score of zero indicates that the item is a weak match for the candidate node and a matching score of one indicates that the item is a strong match for the candidate node. In this example, the matching score may be proportional to a number of items included in a group of items represented by the candidate node that are included in the same level of a hierarchical taxonomy that includes the item or a percentage of attributes (e.g., an item category, ingredients/materials, a version/variety, etc.) shared by the item and the group of items.

In some embodiments, the scoring module 260 predicts a matching score for a combination of an item and a candidate node using a matching prediction model, which is a machine-learning model trained to predict a matching score for a combination of an item and a candidate node. To use the matching prediction model, the scoring module 260 may access the model (e.g., from the data store 240) and apply the model to a set of inputs. The set of inputs may include a set of item data for an item and a set of node data describing a candidate node. For example, the set of inputs may include a set of item data (e.g., an item category, a brand, a size, etc.) for an item and a set of node data describing a group of items represented by a candidate node, such as attributes of the group of items (e.g., one or more item categories associated with the group of items, a level of a hierarchical taxonomy associated with the group of items, etc.). The scoring module 260 may then receive an output from the model, which may include a value corresponding to a matching score for a combination of the item and the candidate node. In some embodiments, the matching prediction model is trained by the machine-learning training module 230, as described above.

The scoring module 260 may communicate a matching score to the data collection module 200, which may store the matching score in the data store 240. A matching score for a combination of an item and a candidate node may be stored among a set of item data for the item or among a set of node data for the candidate node. A matching score may be stored in association with a time at which it was predicted or any other suitable types of information.

In some embodiments, the scoring module 260 identifies or adjusts a threshold matching score used by the item assignment module 270 (described below) to assign items to candidate nodes. In such embodiments, the scoring module 260 may do so based on user data, order data, purchase data, or any other suitable types of information. For example, based on a set of order data describing measures of satisfaction of users with replacements for items assigned to a candidate node included in orders placed by the users, the scoring module 260 may identify a threshold matching score for assigning items to the candidate node. In this example, the scoring module 260 may later adjust the threshold matching score by increasing it if at least a threshold number or percentage of users were unsatisfied with replacements for one or more items assigned to the candidate node. In various embodiments, different candidate nodes may be associated with different threshold matching scores (e.g., based on item categories or other attributes associated with items assigned to the candidate nodes).

Once the scoring module 260 predicts a matching score for each combination of an item and a candidate node of multiple candidate nodes generated by the node generation module 250, the item assignment module 270 assigns the item to a candidate node. The item assignment module 270 may do so based on the matching score predicted for each combination including the item, such that the item is assigned to a candidate node associated with a highest matching score if the matching score is at least a threshold matching score. In some embodiments, the item assignment module 270 assigns the item to the candidate node based on a ranking of the matching scores. For example, suppose that the node generation module 250 has generated 500 candidate nodes and that the scoring module 260 has predicted a matching score for each combination of an item and a candidate node. In this example, the item assignment module 270 may rank the 500 matching scores from highest to lowest, identify the candidate node associated with the highest rank, and assign the item to the identified candidate node if the matching score is at least a threshold score.

Once the item assignment module 270 assigns each of multiple items available at source locations in multiple geographical regions to a candidate node, the availability module 280 may retrieve information describing an availability of each item in each of the geographical regions. Information describing an availability of an item in a geographical region may be received from one or more source computing systems 120 or predicted (e.g., using an availability model, as described above). In embodiments in which information describing an availability of an item in a geographical region is predicted, the availability may be predicted based on a set of item data for the item (e.g., for each item-source combination for a geographical region, information describing a time that the item was last found, a time that the item was last not found, a rate at which the item is found, or a popularity of the item). Additionally, an availability of an item in a geographical region may be predicted based on order or purchase data, such as information describing items included in previous orders or purchases made by users associated with the geographical region, information indicating whether any items included in the previous orders were not available, etc.

To ensure that at least one item assigned to each candidate node selected by the node selection module 290 (described below) to include in a region- and source-agnostic catalog has at least a threshold availability in each of multiple geographical regions, the availability module 280 also may identify an average availability of one or more items assigned to each candidate node across the geographical regions. For example, the availability module 280 may identify an average availability of items assigned to a candidate node across multiple geographical regions by summing the availabilities of the items and dividing the total by the number of geographical regions. The availability module 280 also may weight the average availability of the items based on a number of orders associated with each geographical region, a number of orders including each type of item, etc. For example, availabilities of items in each geographical region may be weighted in proportion to a number of orders including items collected from source locations within the geographical region, such that availabilities in geographical regions associated with more orders are weighted more heavily than availabilities in geographical regions associated with fewer orders. In some embodiments, the geographical regions across which the availability module 280 identifies an average availability of one or more items assigned to each candidate node is specified by or associated with an entity (e.g., a third-party application developer, a social media influencer, etc.).

The node selection module 290 may identify whether an average availability of one or more items assigned to each of multiple candidate nodes across multiple geographical regions is at least a threshold availability and select a set of nodes from the candidate nodes to include in a region- and source-agnostic catalog based on the identification. The node selection module 290 may do so by comparing the average availability of the items assigned to each candidate node across the geographical regions to the threshold availability and identifying whether the average availability of the items is at least the threshold availability based on the comparison. The node selection module 290 may then select the set of nodes from the candidate nodes to include in the region- and source-agnostic catalog based on the comparison, such that the average availability of the items assigned to each selected node across the geographical regions is at least the threshold availability. Once the node selection module 290 selects the set of nodes to include in the region- and source-agnostic catalog, it may communicate information describing the catalog (e.g., attributes of a group of items each node represents, attributes of one or more items assigned to each node, etc.) to the data collection module 200, which may store it among the catalog data in the data store 240.

In some embodiments, the node selection module 290 identifies or adjusts a threshold availability it uses to select a set of nodes from candidate nodes to include in a region- and source-agnostic catalog. In such embodiments, the node selection module 290 may do so based on order data, purchase data, or any other suitable types of information. For example, the node selection module 290 may identify a threshold availability with which to compare an average availability of one or more items assigned to a candidate node across multiple geographical regions, in which the threshold availability corresponds to a default threshold availability. In this example, based on order or purchase data, if at least a threshold number or percentage of pickers or users in one or more of the geographical regions were unable to find any items assigned to the candidate node, the node selection module 290 may adjust the threshold availability by increasing it. In various embodiments, different candidate nodes may be associated with different threshold availabilities.

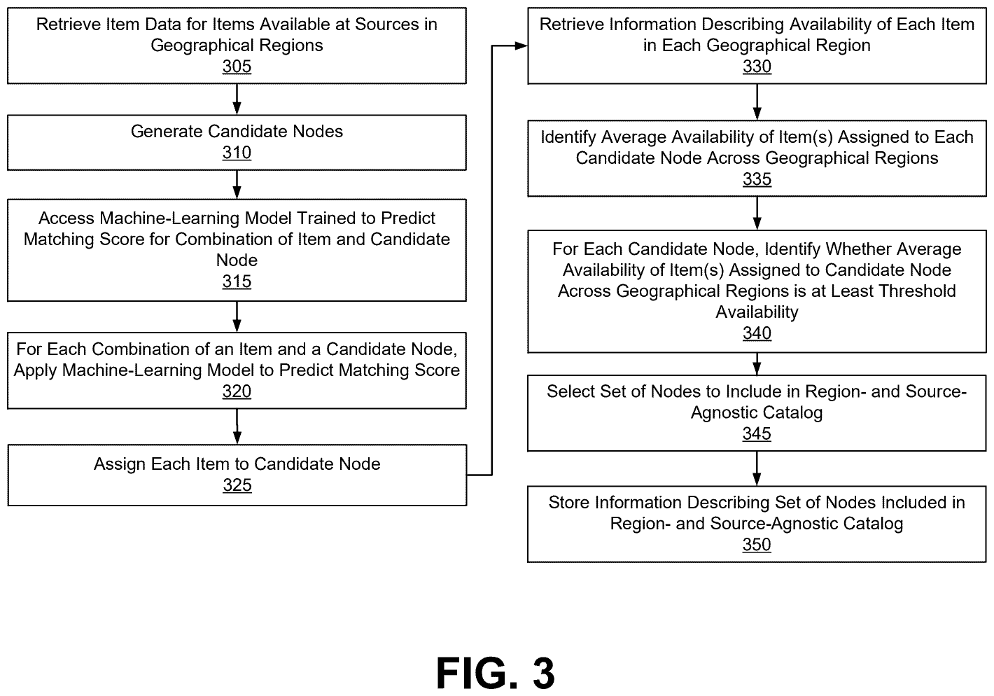

FIG. 3 is a flowchart for a method of generating a region- and source-agnostic catalog of items available at source locations in multiple geographical regions using machine learning, in accordance with some embodiments. Alternative embodiments may include more, fewer, or different steps from those illustrated in FIG. 3, and the steps may be performed in a different order from that illustrated in FIG. 3. These steps may be performed by an online system (e.g., online system 140). Additionally, each of these steps may be performed automatically by the online system without human intervention.

The online system 140 retrieves 305 (e.g., using the node generation module 250) a set of item data for each of multiple items available at multiple source locations, in which each source location is located in a different geographical region included among multiple geographical regions. Examples of geographical regions include counties, states, or countries or areas within a county, a state, or a country. In embodiments in which the item data includes a hierarchical taxonomy into which items available at each source location are organized, the online system 140 also may retrieve 305 the hierarchical taxonomy for each source location.

The online system 140 then generates (step 310, e.g., using the node generation module 250) multiple candidate nodes based on the set of item data for each item, in which each candidate node represents a group of items having at least a threshold measure of similarity to each other. In some embodiments, the online system 140 generates 310 the candidate nodes using item embeddings describing the items, which may be generated by a machine-learning model and stored (e.g., in the data store 240). In such embodiments, the online system 140 may group (e.g., using the node generation module 250) the item embeddings into clusters using a clustering algorithm (e.g., k-means, hierarchical clustering, etc.) and generate 310 the candidate nodes based on the clusters (e.g., such that each candidate node corresponds to a cluster and represents a group of items associated with item embeddings included in the cluster). In various embodiments, the online system 140 generates 310 the candidate nodes based on a level of a taxonomy (e.g., a hierarchical taxonomy) associated with each item. In some embodiments, the candidate nodes are manually curated. Once the online system 140 generates 310 a candidate node, it may store (e.g., using the data collection module 200) information describing the candidate node (e.g., attributes of a group of items the candidate node represents) among the node data (e.g., in the data store 240).

For each combination of an item of the multiple items available at the source locations in the geographical regions and a candidate node of the multiple candidate nodes generated 310 by the online system 140, the online system 140 predicts (e.g., using the scoring module 260) a matching score for a corresponding combination. A matching score may correspond to a value (e.g., from zero to one) that indicates a measure of appropriateness of matching an item with a candidate node based on a measure of similarity between the item and other items that are members of a group of items represented by the candidate node. The online system 140 may predict a matching score for a combination of an item and a candidate node based on a set of item data for the item (e.g., a set of attributes of the item) and a set of node data for the candidate node (e.g., a set of attributes of a group of items represented by the candidate node).

In some embodiments, the online system 140 predicts a matching score for a combination of an item and a candidate node using a matching prediction model, which is a machine-learning model trained to predict a matching score for a combination of an item and a candidate node. To use the matching prediction model, the online system 140 may access 315 (e.g., using the scoring module 260) the model (e.g., from the data store 240) and apply 320 (e.g., using the scoring module 260) the model to a set of inputs. The set of inputs may include a set of item data for an item and a set of node data describing a candidate node. The online system 140 may then receive (e.g., via the scoring module 260) an output from the model, which may include a value corresponding to a matching score for a combination of the item and the candidate node. In some embodiments, the matching prediction model is trained by the online system 140 (e.g., using the machine-learning training module 230).

The online system 140 may then store (e.g., using the data collection module 200) each matching score (e.g., in the data store 240). A matching score for a combination of an item and a candidate node may be stored among a set of item data for the item or among a set of node data for the candidate node. A matching score may be stored in association with a time at which it was predicted or any other suitable types of information.

In some embodiments, the online system 140 identifies (e.g., using the scoring module 260) or adjusts (e.g., using the scoring module 260) a threshold matching score it uses to assign (step 325) items to candidate nodes, as described below. In such embodiments, the online system 140 may do so based on user data, order data, purchase data, or any other suitable types of information. In various embodiments, different candidate nodes may be associated with different threshold matching scores (e.g., based on item categories or other attributes associated with items assigned 325 to the candidate nodes).

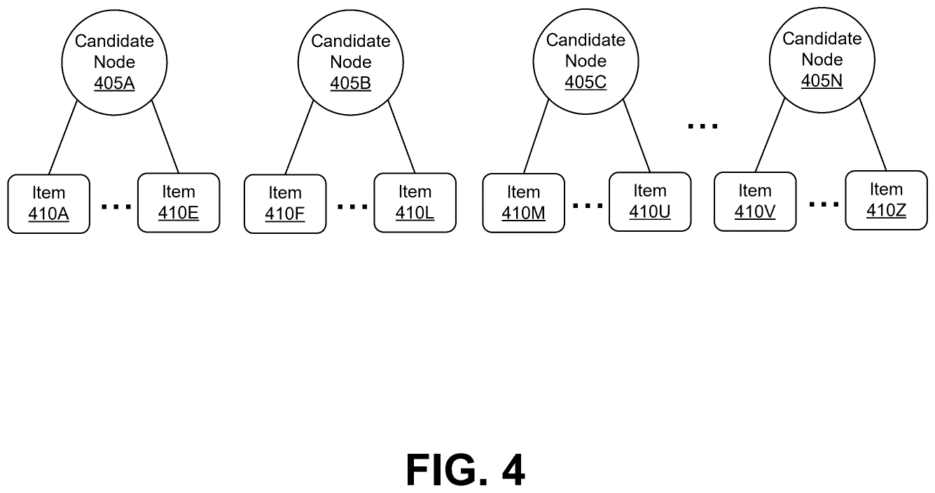

The online system 140 then assigns 325 (e.g., using the item assignment module 270) each item to a candidate node. The online system 140 may do so based on the matching score predicted for each combination including the item, such that the item is assigned 325 to a candidate node associated with a highest matching score if the matching score is at least a threshold matching score. For example, as shown in FIG. 4, which illustrates examples of items assigned to candidate nodes, in accordance with one or more embodiments, suppose that the online system 140 has predicted matching scores for each combination including item 410A and a candidate node 405A-N. In this example, if the matching score predicted for the combination including item 410A and candidate node 405A was the highest, the online system 140 may assign 325 item 410A to candidate node 405A if the matching score is at least a threshold matching score. In this example, the online system 140 may assign (step 325) items 410B-Z to the candidate nodes 405A-N in a similar manner. In some embodiments, the online system 140 assigns 325 each item 410 to a candidate node 405 based on a ranking of the matching scores.

Referring back to FIG. 3, once the online system 140 assigns 325 each item 410 to a candidate node 405, the online system 140 may retrieve 330 (e.g., using the availability module 280) information describing an availability of each item 410 in each of the geographical regions. Information describing an availability of an item 410 in a geographical region may be received from one or more source computing systems 120 or predicted (e.g., using an availability model, as described above). In embodiments in which information describing an availability of an item 410 in a geographical region is predicted, the availability may be predicted based on a set of item data for the item 410 (e.g., for each item-source combination for a geographical region, information describing a time that the item 410 was last found, a time that the item 410 was last not found, a rate at which the item 410 is found, or a popularity of the item 410). Additionally, an availability of an item 410 in a geographical region may be predicted based on order or purchase data, such as information describing items 410 included in previous orders or purchases made by users associated with the geographical region, information indicating whether any items 410 included in the previous orders were not available, etc.

The online system 140 may ensure that at least one item 410 assigned 325 to each candidate node 405 selected 345 by the online system 140 (described below) to include in a region- and source-agnostic catalog has at least a threshold availability in each of the geographical regions. The online system 140 may do so by identifying 335 (e.g., using the availability module 280) an average availability of one or more items 410 assigned 325 to each candidate node 405 across the geographical regions (e.g., by summing the availabilities and dividing the total by the number of geographical regions). The online system 140 also may weight (e.g., using the availability module 280) the average availability of the items 410 based on a number of orders associated with each geographical region, a number of orders including each type of item 410, etc. In some embodiments, the geographical regions across which the online system 140 identifies 335 the average availability of the items 410 assigned 325 to each candidate node 405 is specified by or associated with an entity (e.g., a third-party application developer, a social media influencer, etc.).

For each candidate node 405, the online system 140 may identify 340 (e.g., using the node selection module 290) whether an average availability of one or more items 410 assigned 325 to each candidate node 405 across the geographical regions is at least a threshold availability and select 345 (e.g., using the node selection module 290) a set of nodes from the candidate nodes 405 to include in the region- and source-agnostic catalog based on the identification. The online system 140 may do so by comparing (e.g., using the node selection module 290) the average availability of the items 410 assigned 325 to each candidate node 405 across the geographical regions to the threshold availability and identifying 340 whether the average availability is at least the threshold availability based on the comparison. The online system 140 may then select 345 the set of nodes from the candidate nodes 405 to include in the region- and source-agnostic catalog based on the comparison, such that the average availability of the items 410 assigned 325 to each selected node across the geographical regions is at least the threshold availability. Once the online system 140 selects 345 the set of nodes 510 to include in the region- and source-agnostic catalog 515, it may store 350 (e.g., using the data collection module 200) information describing the catalog (e.g., attributes of a group of items 410 each node 510 represents, attributes of one or more items 410 assigned 325 to each node 510, etc. in the data store 240).

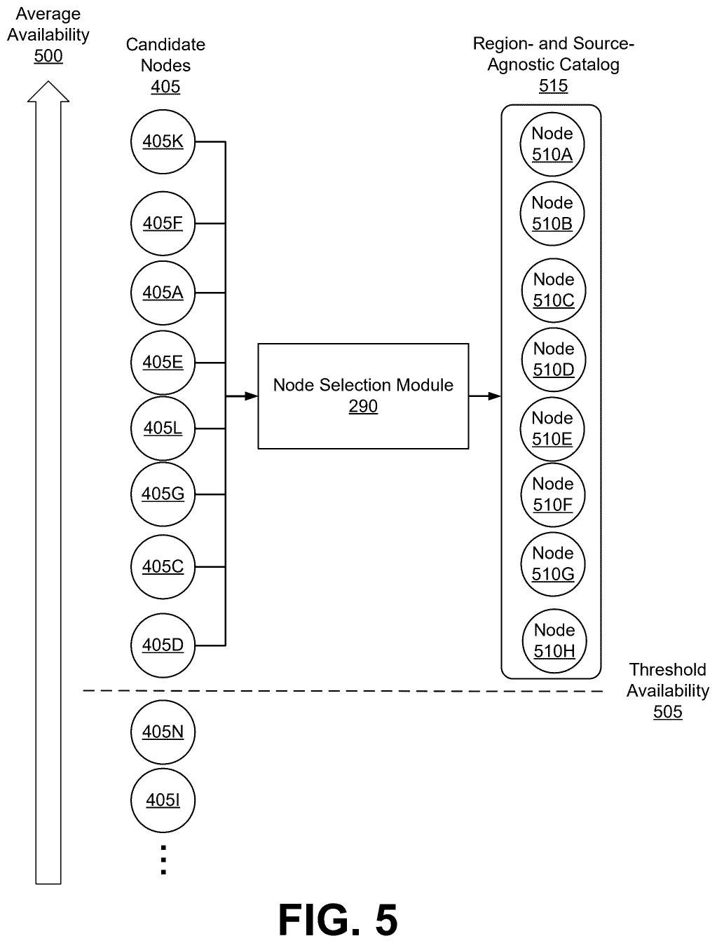

FIG. 5 illustrates an example of nodes included in a region- and source-agnostic catalog, in accordance with one or more embodiments, and continues the example described above in conjunction with FIG. 4. As shown in FIG. 5, based on a comparison of the average availability 500 of the items 410 assigned 325 to each candidate node 405 across the geographical regions with the threshold availability 505, the online system 140 may select 345 a set of nodes 510A-H to include in the region- and source-agnostic catalog 515. In this example, node 505A was formerly candidate node 405K, node 510B was formerly candidate node 405F, etc.

In some embodiments, the online system 140 identifies (e.g., using the node selection module 290) or adjusts (e.g., using the node selection module 290) the threshold availability 505 it uses to select 345 the set of nodes 510 from the candidate nodes 405 to include in the region- and source-agnostic catalog 515. In such embodiments, the online system 140 may do so based on order data, purchase data, or any other suitable types of information (e.g., by increasing the threshold availability 505 if at least a threshold number or percentage of pickers or users in one or more of the geographical regions were unable to find any items 410 assigned 325 to a candidate node 405). In various embodiments, different candidate nodes 405 may be associated with different threshold availabilities 505.

The online system 140 subsequently may receive (e.g., via the content presentation module 210) a request from a user client device 100 associated with a user to access a user interface (e.g., the ordering interface) including information describing a set of items 410 assigned 325 to one or more nodes 510 included in the region- and source-agnostic catalog 515. The online system 140 may then retrieve (e.g., using the content presentation module 210) a set of item data for each item 410 (e.g., from the data store 240) and generate (e.g., using the content presentation module 210) the user interface including information describing the set of items 410. In some embodiments, the online system 140 also retrieves (e.g., using the content presentation module 210) a set of user data for the user describing a geographical location associated with the user and identifies (e.g., using the content presentation module 210) a subset of the set of items 410 available at one or more source locations within a threshold distance of the geographical location associated with the user or within the same geographical region as the geographical location associated with the user. In such embodiments, the online system 140 then generates the user interface including information describing the subset of the set of items 410. Once the online system 140 generates the user interface, the online system 140 may then send (e.g., using the content presentation module 210) the user interface to the user client device 100, causing the user client device 100 to display the user interface.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
retrieving, at an online system, a set of item data for each item of a plurality of items available at a plurality of source locations, wherein each source location of the plurality of source locations is located in a different region of a plurality of regions;
generating a plurality of candidate nodes based at least in part on the set of item data for each item of the plurality of items, wherein each candidate node of the plurality of candidate nodes represents a group of items having at least a threshold measure of similarity to each other;
accessing a machine-learning model trained to predict a matching score for a combination of an item and a candidate node;
for each combination of an item of the plurality of items and a candidate node of the plurality of candidate nodes, applying the machine-learning model to predict the matching score for a corresponding combination based at least in part on the set of item data for a corresponding item and a set of attributes of the group of items represented by a corresponding candidate node;
assigning each item of the plurality of items to a candidate node of the plurality of candidate nodes based at least in part on the matching score predicted for each combination;
retrieving availability information describing an availability of each item of the plurality of items in each region of the plurality of regions;
identifying an average availability of one or more items assigned to each candidate node of the plurality of candidate nodes across the plurality of regions based at least in part on the availability information describing the availability of each item of the plurality of items in each region of the plurality of regions;
for each candidate node of the plurality of candidate nodes, identifying whether the average availability of the one or more items assigned to a corresponding candidate node across the plurality of regions is at least a threshold availability;
selecting, from the plurality of candidate nodes, a set of nodes to include in a region- and source-agnostic item database, wherein the average availability of the one or more items assigned to each selected node is at least the threshold availability; and
storing information describing the selected set of nodes included in the region- and source-agnostic item database.

2. The method of claim 1, wherein generating the plurality of candidate nodes based at least in part on the set of item data for each item of the plurality of items comprises:
generating an item embedding for each item of a set of items available at the plurality of source locations based at least in part on the set of item data for each item of the set of items;
grouping a set of item embeddings generated for the set of items into a plurality of clusters using a clustering algorithm; and
generating the plurality of candidate nodes based at least in part on the plurality of clusters.

3. The method of claim 1, wherein generating the plurality of candidate nodes based at least in part on the set of item data for each item of the plurality of items comprises:
generating the plurality of candidate nodes based on a level of a taxonomy associated with each item of the plurality of items.

4. The method of claim 1, wherein identifying the average availability of the one or more items assigned to each candidate node of the plurality of candidate nodes across the plurality of regions based at least in part on the availability information describing the availability of each item of the plurality of items in each region of the plurality of regions comprises:
weighting the average availability based at least in part on a number of orders associated with each region of the plurality of regions.

5. The method of claim 1, further comprising:
adjusting the threshold availability for each candidate node of the plurality of candidate nodes based at least in part on information describing whether one or more of a plurality of pickers or a plurality of users were able to find one or more items assigned to a corresponding candidate node.

6. The method of claim 1, wherein assigning each item of the plurality of items to a candidate node of the plurality of candidate nodes based at least in part on the matching score predicted for each combination comprises:
assigning each item of the plurality of items to a candidate node of the plurality of candidate nodes based on a threshold matching score.

7. The method of claim 6, wherein assigning each item of the plurality of items to a candidate node of the plurality of candidate nodes based at least on the threshold matching score comprises:
assigning each item of the plurality of items to a candidate node of the plurality of candidate nodes if the matching score predicted for a corresponding combination of an item and a candidate node is at least the threshold matching score.

8. The method of claim 6, further comprising:
adjusting the threshold matching score based at least in part on a measure of satisfaction of one or more users with one or more replacements for one or more items assigned to a candidate node.

9. The method of claim 1, further comprising:
receiving, from a client device associated with a user of the online system, a request to access a user interface comprising information describing a set of items assigned to one or more nodes included in the region- and source-agnostic item database;
retrieving the set of item data for each item of the set of items;
generating the user interface comprising information describing the set of items; and
sending the user interface to the client device associated with the user, causing the client device to display the user interface.

10. The method of claim 1, further comprising:
training the machine-learning model by:
receiving the set of attributes of the group of items represented by each candidate node of the plurality of candidate nodes,
receiving a set of additional attributes of a set of items,
receiving, for each item of the set of items and each candidate node of the plurality of candidate nodes, a label indicating a measure of appropriateness of matching a corresponding item with a corresponding candidate node, and
updating a set of parameters of the machine-learning model based at least in part on the set of attributes, the set of additional attributes, and the label for each item of the set of items and each candidate node of the plurality of candidate nodes.

11. A computer program product comprising a non-transitory computer-readable storage medium having instructions encoded thereon that, when executed by a processor, cause the processor to perform steps comprising:
retrieving, at an online system, a set of item data for each item of a plurality of items available at a plurality of source locations, wherein each source location of the plurality of source locations is located in a different region of a plurality of regions;
generating a plurality of candidate nodes based at least in part on the set of item data for each item of the plurality of items, wherein each candidate node of the plurality of candidate nodes represents a group of items having at least a threshold measure of similarity to each other;
accessing a machine-learning model trained to predict a matching score for a combination of an item and a candidate node;
for each combination of an item of the plurality of items and a candidate node of the plurality of candidate nodes, applying the machine-learning model to predict the matching score for a corresponding combination based at least in part on the set of item data for a corresponding item and a set of attributes of the group of items represented by a corresponding candidate node;
assigning each item of the plurality of items to a candidate node of the plurality of candidate nodes based at least in part on the matching score predicted for each combination;
retrieving availability information describing an availability of each item of the plurality of items in each region of the plurality of regions;
identifying an average availability of one or more items assigned to each candidate node of the plurality of candidate nodes across the plurality of regions based at least in part on the availability information describing the availability of each item of the plurality of items in each region of the plurality of regions;
for each candidate node of the plurality of candidate nodes, identifying whether the average availability of the one or more items assigned to a corresponding candidate node across the plurality of regions is at least a threshold availability;
selecting, from the plurality of candidate nodes, a set of nodes to include in a region- and source-agnostic item database, wherein the average availability of the one or more items assigned to each selected node is at least the threshold availability; and
storing information describing the selected set of nodes included in the region- and source-agnostic item database.

12. The computer program product of claim 11, wherein generating the plurality of candidate nodes based at least in part on the set of item data for each item of the plurality of items comprises:
generating an item embedding for each item of a set of items available at the plurality of source locations based at least in part on the set of item data for each item of the set of items;
grouping a set of item embeddings generated for the set of items into a plurality of clusters using a clustering algorithm; and
generating the plurality of candidate nodes based at least in part on the plurality of clusters.

13. The computer program product of claim 11, wherein generating the plurality of candidate nodes based at least in part on the set of item data for each item of the plurality of items comprises:
generating the plurality of candidate nodes based on a level of a taxonomy associated with each item of the plurality of items.

14. The computer program product of claim 11, wherein identifying the average availability of the one or more items assigned to each candidate node of the plurality of candidate nodes across the plurality of regions based at least in part on the availability information describing the availability of each item of the plurality of items in each region of the plurality of regions comprises:
weighting the average availability based at least in part on a number of orders associated with each region of the plurality of regions.

15. The computer program product of claim 11, wherein the computer-readable storage medium further has instructions encoded thereon that, when executed by the processor, cause the processor to perform steps comprising:
adjusting the threshold availability for each candidate node of the plurality of candidate nodes based at least in part on information describing whether one or more of a plurality of pickers or a plurality of users were able to find one or more items assigned to a corresponding candidate node.

16. The computer program product of claim 11, wherein assigning each item of the plurality of items to a candidate node of the plurality of candidate nodes based at least in part on the matching score predicted for each combination comprises:
assigning each item of the plurality of items to a candidate node of the plurality of candidate nodes based on a threshold matching score.

17. The computer program product of claim 16, wherein assigning each item of the plurality of items to a candidate node of the plurality of candidate nodes based at least on the threshold matching score comprises:
assigning each item of the plurality of items to a candidate node of the plurality of candidate nodes if the matching score predicted for a corresponding combination of an item and a candidate node is at least the threshold matching score.

18. The computer program product of claim 16, wherein the computer-readable storage medium further has instructions encoded thereon that, when executed by the processor, cause the processor to perform steps comprising:
adjusting the threshold matching score based at least in part on a measure of satisfaction of one or more users with one or more replacements for one or more items assigned to a candidate node.

19. The computer program product of claim 11, wherein the computer-readable storage medium further has instructions encoded thereon that, when executed by the processor, cause the processor to perform steps comprising:
receiving, from a client device associated with a user of the online system, a request to access a user interface comprising information describing a set of items assigned to one or more nodes included in the region- and source-agnostic item database;
retrieving the set of item data for each item of the set of items;
generating the user interface comprising information describing the set of items; and
sending the user interface to the client device associated with the user, causing the client device to display the user interface.

20. A computer system comprising:
a processor; and
a non-transitory computer-readable storage medium storing instructions that, when executed by the processor, perform actions comprising:
retrieving, at an online system, a set of item data for each item of a plurality of items available at a plurality of source locations, wherein each source location of the plurality of source locations is located in a different region of a plurality of regions;
generating a plurality of candidate nodes based at least in part on the set of item data for each item of the plurality of items, wherein each candidate node of the plurality of candidate nodes represents a group of items having at least a threshold measure of similarity to each other;
accessing a machine-learning model trained to predict a matching score for a combination of an item and a candidate node;
for each combination of an item of the plurality of items and a candidate node of the plurality of candidate nodes, applying the machine-learning model to predict the matching score for a corresponding combination based at least in part on the set of item data for a corresponding item and a set of attributes of the group of items represented by a corresponding candidate node;
assigning each item of the plurality of items to a candidate node of the plurality of candidate nodes based at least in part on the matching score predicted for each combination;
retrieving availability information describing an availability of each item of the plurality of items in each region of the plurality of regions;
identifying an average availability of one or more items assigned to each candidate node of the plurality of candidate nodes across the plurality of regions based at least in part on the availability information describing the availability of each item of the plurality of items in each region of the plurality of regions;
for each candidate node of the plurality of candidate nodes, identifying whether the average availability of the one or more items assigned to a corresponding candidate node across the plurality of regions is at least a threshold availability;
selecting, from the plurality of candidate nodes, a set of nodes to include in a region- and source-agnostic item database, wherein the average availability of the one or more items assigned to each selected node is at least the threshold availability; and
storing information describing the selected set of nodes included in the region- and source-agnostic item database.
